(19) United States
(12) Patent Application Publication
(10) Pub. No.: US 2020/0210373 A1
(43) Pub. Date: Jul. 2, 2020

(54) STORAGE ARCHITECTURE FOR MESSAGE OBJECT DATA IN TELECOMMUNICATIONS NETWORKS

(71) Applicant: T-Mobile USA, Inc., Bellevue, WA (US)

(72) Inventor: Chingming Chao, Bellevue, WA (US)

(21) Appl. No.: 16/237,587

(22) Filed: Dec. 31, 2018

(51) Int. Cl. G06F 16/11; G06F 16/16; G06F 3/06; H04W 4/18; H04W 4/14

(52) U.S. Cl. CPC G06F 16/113; G06F 16/116; G06F 16/164; H04W 4/14; G06F 3/0619; H04W 4/18; G06F 3/0616

(57) ABSTRACT

Systems and methods are described herein for storing and/or retaining message object data for subscribers of a wireless network. The systems and methods introduce a storage architecture that retains message objects in both hot storage (or local storage) and cold storage (remote or archive storage), to comply with the OMA and/or GSMA standards. After certain events associated with the message objects occur, such as an expiration of a time-to-live (TTL) parameter for the message objects, the systems and methods purge or remove message objects from the local storage, but maintain the message objects in the remote storage location.

### BACKGROUND

The Open Mobile Alliance CPM (Converged IP Messaging) standard and the Global System for Mobile Communication standard provide various rules and regulations for storing message object data for subscribers of mobile or wireless networks. Message object (MO) data includes SMS data, MMS data, call log data, voice mail files or data, and so on.

These rules and regulations are robust, but fairly rigid regarding the storage and retention of message object data. Carriers providing messaging services over mobile or wireless networks, therefore, provide network resources to store and retain message object data for subscribers. Often, these resources are provided locally (or proximate) to network components that facilitate messaging between subscribers, such as between their mobile devices. However, networks handle millions, if not billions, of message objects on a regular basis, and typical methods and systems for storing and retaining message object data are not suited or configured to retain such large amounts of data.

### BRIEF DESCRIPTION OF THE DRAWINGS

Embodiments of the present technology will be described and explained through the use of the accompanying drawings.

FIG. 1 is a block diagram illustrating a suitable computing environment for retaining message object data.

FIG. 2 is a block diagram illustrating various modules of an object retention system.

FIG. 3 is a flow diagram illustrating a method for storing message object data for a network carrier.

FIG. 4 is a flow diagram illustrating a method for selecting a storage device as a storage target for message object data.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

### Overview

Systems and methods are described herein for storing and/or retaining message object data for subscribers of a wireless network. The systems and methods (collectively “systems”) introduce a storage architecture that retains message objects in both “hot” or local storage (or local or readily accessible storage) and “cold” storage (remote or archive storage), to comply with the OMA and/or GSMA standards. After certain events associated with the message objects occur, such as elapsing of a time-to-live (TTL) parameter for the message objects, the systems purge or remove message objects from the local storage, but maintain the message objects in the remote storage location.

For example, the systems can attach TTL parameters or values to message objects, and modify an index, metadata, or other data structure that tracks locations of the data objects when the TTL lapses or expires, such that the data structure points to the remotely stored message objects. Thus, the architecture can comply with the various standards while utilizing the hot or local storage as a cache for the network, by sending all message object data to cold storage for medium- and/or long-term storage and retention, and tracking the message object data using metadata or other indexing information at the local storage location.

In doing so, the systems provide storage mechanisms and devices that comply with data storage standards adopted by OMA and GSMA, while also moving message object data into more suitable data storage locations (e.g., cold storage), which often store data using inexpensive storage devices specifically configured for long-term data retention.

In some implementations, the systems employ a method for storing message object data for a telecommunications network by receiving, at a local storage device, message objects sent between subscribers of a telecommunications network, and assigning, to the message objects, a time-to-live (TTL) value to the one or more message objects.

The method then retains the message objects by storing them in the local storage device, and updating a metadata index at the local storage device with information that identifies a location of the message objects as being at the local storage device, and storing the one or more message objects to a cold storage device associated with the local storage device. Then, when the TTL value assigned to the message objects lapses, the method updates the metadata index at the local storage device with information that indicates the one or more message objects are stored in the cold storage device.

Thus, the systems and methods, as described herein, enable a telecommunications network to retain message object data fully in compliance with various network standards, while also utilizing appropriate, cost-effective, and/or optimized resources for storing the message objects at various times during retention of the objects. Given that many networks provide robust messaging and data communication services to their subscribers, which routinely handle billions and billions of messages over a week (or even a day), such a storage architecture enables a network carrier to retain copies of the messages without undue costs or inefficiencies, among other benefits.

In the following description, for the purposes of explanation, numerous specific details are set forth in order to provide a thorough understanding of embodiments of the present technology. It will be apparent, however, that embodiments of the present technology can be practiced without some of these specific details.

### Examples of Suitable Network Environments

As described herein, in some embodiments, the systems and methods enable a carrier network, or portions thereof, to store and retain message object data in compliance with various standards without relying on use of expensive or other primary storage resources to actively store the data.

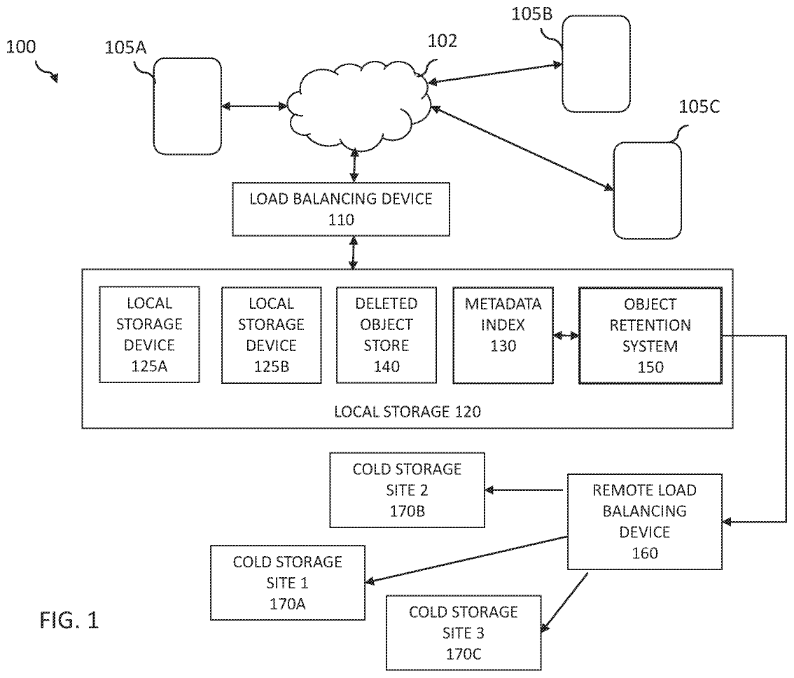

FIG. 1 is a block diagram illustrating a suitable computing environment 100 for retaining message object data. A telecommunications network 102, such as a wireless or mobile network (as described herein), provides various communication services to mobile devices 105A-C. For example, mobile devices 105A-C, which can be smartphones, laptops, tablets, and so on, communicate with one another over the network 102 by sending messages (SMS, MMS, text, and so on), making voice calls, and so on.

The mobile devices 105A-C can include various different types of clients or mobile applications that provide messaging and other communication platforms, including clients native to the devices 105A-C (e.g., the text message or voice call client of a smartphone), mobile application downloaded to the devices 105A-C (e.g., messaging applications, chat applications, instant message applications, social media or networking applications, enterprise applications, and so on), and others.

Further, the network carrier providing the communications network 102 can provide a client or application for its subscribers, such as users associated with the mobile devices 105A-C. The carrier provided client or application, in some cases, enables a user or subscriber to communicate via a single phone number across multiple mobile devices. For example, a message sent from mobile device 105A to subscriber associated with mobile device 105B (e.g., a smartphone) and mobile device 105C (e.g., a tablet) can reach the subscriber via either of the devices 105B or 105, via the application. An example application providing such functionality can include the “Digits”™ application or service, provided by T-Mobile.

As described herein, the telecommunications network 102 handles billions and billions of messages, and, based on OMA and/or GSMA data retention standards, retains copies of the messages, or message objects, in local, or hot, storage 120. Local storage 120 includes various local storage devices 125A-B (or more), a delete object database 140, and a metadata index 130 that tracks locations of the copies of the message objects in the local storage devices 125A-B.

Because the telecommunications network 102 covers a large geographical area (e.g., a region, or area, or city, or country), the local storage 120 provides multiple different storage sites at various different geographical locations. Further, at each location, the local storage 120 can include multiple local storage devices 125A and 125B (and, not shown, other devices). The local storage devices 125A-B can be primary storage, retaining message objects in storage media that facilitates fast search and retrieval of the message objects, when requested. However, such storage media is expensive and often inefficient for long-term data retention uses.

The telecommunications network 102 can utilize a load balancing device 110 when storing data to one or more of the local storage devices 125A-B. For example, the load balancing device 110 (e.g., a Global Traffic Manager by F5 Networks), can select one or more local storage devices 125A-B at which to store message objects based on a variety of conditions, such as network throughput conditions, location conditions, network performance conditions, and so on.

As described herein, storing and retaining the message objects in the local storage 120 satisfies the standards set forth by the OMA and/or GSMA. However, the systems and methods described herein have enhanced the storage architecture to continue to satisfy the standards while also utilizing storage resources better suited for long-term data object retention.

The enhanced storage architecture includes multiple cold storage sites 170A-C, which include storage media suitable for long-term data storage (e.g., disk arrays, tapes, and other data archive media). Further, the remote load balancing device 160 (e.g., similar to load balancing device 110) determines where to store message objects when transferred to cold storage (e.g., which of storage sites 170A-C).

However, simply sending message objects to the cold, or secondary, storage sites 170A-C can run contrary to the message object retention standards. Thus, the systems and methods provide an object retention system 150, which modifies the metadata index 130 to track locations of message objects based on time-to-live (TTL) occurrences for the message objects.

While depicted as a separate component from the metadata index 130, in various embodiments, some or all aspects of the system 150 are part of the metadata index 130, and function to modify the index 130 as a combined system.

Thus, the systems and methods modify use of the local storage 120 with the object retention system 150 in order to seamlessly store copies of message objects at both locations (e.g., hot storage 120 and cold storage sites 170A-C), and fully comply with data retention standards. Utilizing TTL mechanisms (e.g., similar to TTL mechanisms for data caches), the object retention system 150 ensures message objects are retained (e.g., storing copies at both cold and hot locations initially and simultaneously), without unnecessarily keeping copies of message objects in expensive storage media (e.g., local storage devices 125A-C) during long-term (e.g., 7 years) retention of the message objects. Further details regarding the processes performed by the object retention system 150 are described herein.

FIG. 1 and the discussion herein provide a brief, general description of a suitable computing environment in which the object retention system 150 or other components can be supported and implemented. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or another scheme). Portions of the system can reside on a server computer, while corresponding portions can reside on a client computer such as a mobile or portable device, and thus, while certain hardware platforms are described herein, aspects of the system are equally applicable to nodes on a network. In an alternative embodiment, the mobile device or portable device can represent the server portion, while the server can represent the client portion.

In some embodiments, the devices can include network communication components that enable the devices to communicate with remote servers or other portable electronic devices by transmitting and receiving wireless signals using a licensed, semi-licensed, or unlicensed spectrum over communications networks. In some cases, the telecommunication network can be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The communications network can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), or other 3GPP or non-3GPP communications networks.

### Examples of Retaining Message Object Data

As described herein, in some embodiments, local storage 120 for a telecommunications network includes or otherwise provides an object retention system 150, which facilitates storing or retaining of message object data (e.g., copies of message objects), at both the local storage devices 125-A-B and remote, or cold, storage sites or devices 170A-C.

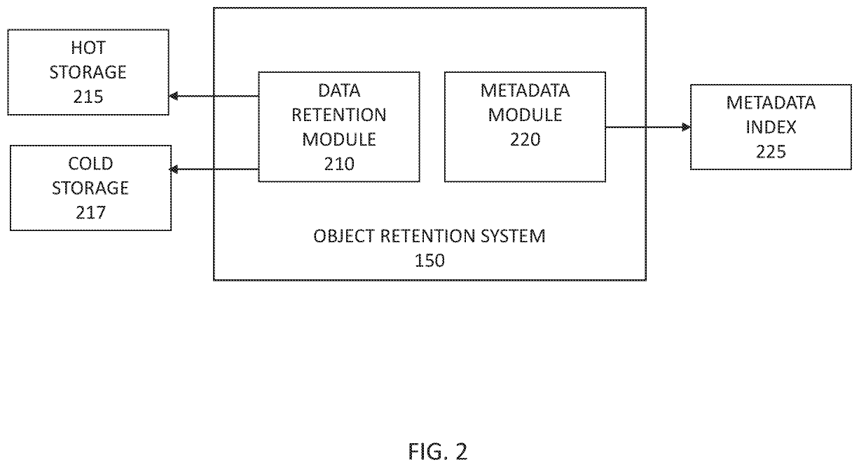

FIG. 2 is a block diagram illustrating various modules of the object retention system 150. The object retention system 150 includes functional modules or engines that are implemented with a combination of software (e.g., executable instructions, or computer code) and hardware (e.g., at least a memory and processor). Accordingly, as used herein, in some examples a module or engine is a processor-implemented module or set of code and represents a computing device having a processor that is at least temporarily configured and/or programmed by executable instructions stored in memory to perform one or more of the particular functions that are described herein. For example, the object retention system 150 includes a data storage module or component 210 and a metadata module or component 220.

In some embodiments, the data storage module or component 210 is configured and/or programmed to simultaneously store message object data to two separate storage locations. For example, the data storage module 210 can facilitate transfer of copies of message objects to both hot storage 215 (e.g., devices 125A or 125B) that stores message data objects for the telecommunications network 102 (under the various standards), and cold storage 217 (e.g., cold storage sites 170A-C) that also stores the message data objects for the telecommunications network 102. Thus, in some cases, the data storage module 210 ensures that message objects are simultaneously stored at both hot and cold storage locations.

In some embodiments, the metadata module or component 220 is configure and/or programmed to track locations of the message data objects, such as locations associated with the hot storage 215 or the cold storage 217. For example, the metadata module 220 can update or include a data structure (e.g., a metadata index 225 or 130). The metadata index 225 or 130 can point to or include references to locations of the message objects. Following the time-to-live mechanism applied to the message objects stored at the local storage device, the metadata module 220 can modify the index 225 to point to the local storage 215 before the time-to-live (TTL) applied to the message data objects elapses, and then modify the index 225 to point or refer to the message data objects stored at the remote storage device 217 when the TTL elapses or tolls. As described, herein the index 225 or 130 can also include voicemail information and RCS (rich communication service) or RMS messages.

Thus, in some embodiments, the object retention system 150 is placed at, within, or associated with the local storage 120 (e.g., within index 130) in order to facilitate utilization of the metadata index 130 (or, index 225) at the local storage 120 for tracking and maintain metadata for message objects, which is useful for restoration or retrieval of the message objects. However, the object retention system 150 also leverages the metadata index 130 or 225 to send the message objects to cold storage 217, where the message objects are retained using inexpensive and suitable storage media.

As described herein, the object retention system 150 can follow or employ specific processes or methods for ensuring message objects are retained properly and in compliance with certain mobile standards, while also maintaining the message objects at more suitable storage locations, when feasible.

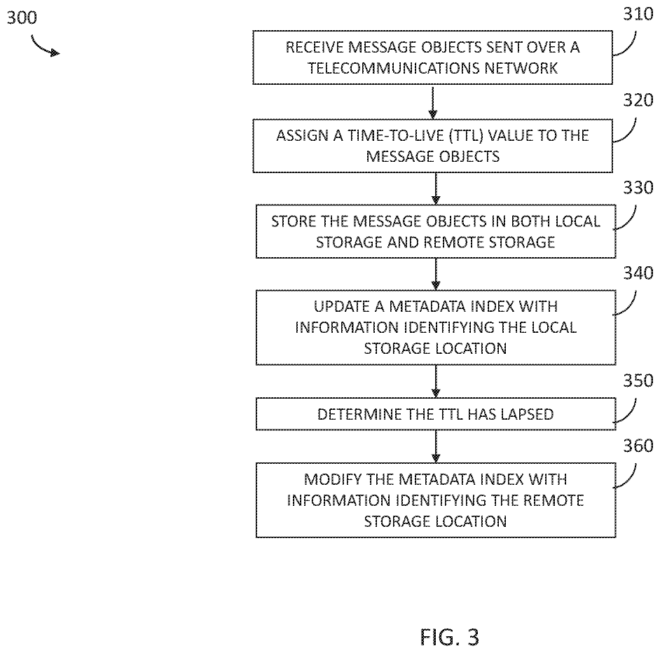

FIG. 3 is a flow diagram illustrating a method 300 for storing message object data for a network carrier. The method 300 can be performed by the object retention system 150 and, accordingly, is described herein merely by way of reference thereto. It will be appreciated that the method 300 can be performed on any suitable hardware.

In operation 310, the object retention system 150 receives, at a local storage device, one or more message objects sent between subscribers of a telecommunications network. For example, the system 150 can access or otherwise receive message objects (or information associated with the message objects) sent between devices 105A, 105B, 105 . . . 105N over the telecommunications network 102. The message objects can include SMS messages, MMS messages, log files or log data associated with messages, calls, and data, voice mail files or messages, and so on.

In operation 320, the object retention system 150 assigns a time-to-live (TTL) value or parameter to the one or more message objects at the local storage device. For example, the system 150 can assign a common TTL value for all messages (e.g., 6 months or one year), can assign different values for different types of messages (e.g., 6 months for MMS messages, 3 months for voice mail messages) can reset TTL values when message objects are accessed by a user, and so on.

In operation 330, the object retention system 150 retains (or, causes to be retained) the one or more message objects by storing the one or more message objects to the local storage device, and storing the one or more message objects to a cold storage device associated with the local storage device. For example, the data storage module 210 can facilitate transfer of copies of message objects to both hot storage 215 (e.g., devices 125A or 125B) that stores message data objects for the telecommunications network 102 (under the various standards), and cold storage 217 (e.g., cold storage sites 170A-C) that also stores the message data objects for the telecommunications network 102.

In some cases, the system 150 can utilize a load balancing device 110 when transferring message objects to the local storage devices 125A-B. For example, the system 150 can store message objects to a local storage device that is selected from a group of available local storage devices based on a proximity of the local storage device to a mobile device or network component associated with the one or more message objects in the telecommunications network, based on network performance or conditions, and so on.

Further, the object retention system 150 can utilize a cold storage site that is specific to a phone number associated with a message object (and not a device that received or sent the message objects). For example, the system 150 can select the cold storage device from a group of available cold storage devices assigned to a phone number or username associated with a subscriber of the telecommunications network 102.

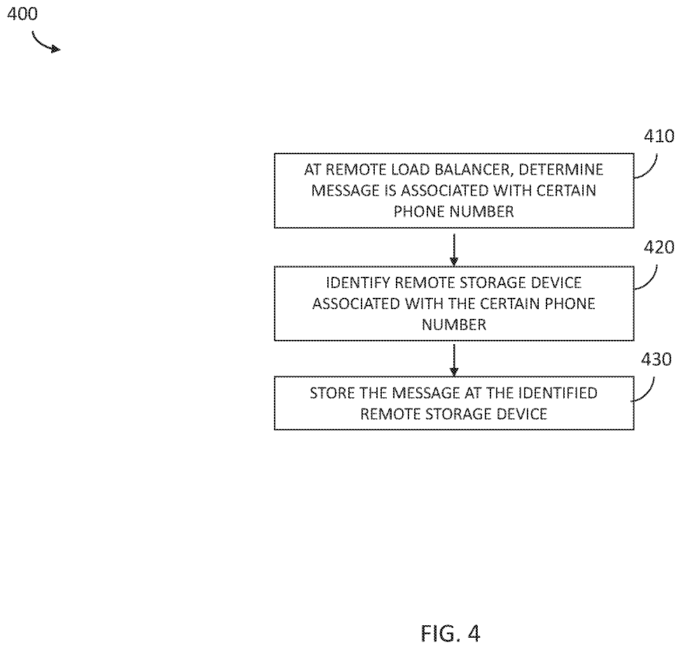

FIG. 4 is a flow diagram illustrating a method 400 for selecting a storage device as a storage target for message object data. The method 400 can be performed by the object retention system 150 and, accordingly, is described herein merely by way of reference thereto. It will be appreciated that the method 400 can be performed on any suitable hardware.

In operation 410, the system 150 determines a message object is associated with a certain phone number. For example, the system 150 determines the message object was sent by and/or received from a certain phone number, such as a phone number assigned to a subscriber of the network 102 (e.g., via a box identity and resource URL, or other open mobile alliance information).

In operation 420, the system 150 identifies a remote storage device associated with the phone number. For example, the system 150 can identify cold storage site 170B as storing all message objects sent from the certain phone number, regardless of the location of the mobile device that sent the message objects.

In operation 430, the system 150 stores the message objects to the identified remote storage device. For example, the system 150 can provide instructions to the load balancing component 160 to store all message objects associated with the certain phone number to the cold storage site 170B.

Returning to FIG. 3, in operation 340, the object retention system 150 updates a metadata index at the local storage device with information that identifies a location of the one or more message objects as being the local storage device. For example, when the message objects are initially stored to both local storage devices 125A-B and cold storage sites 170A-C, the system 150, via the metadata module 220 updates the metadata index 140 or 225 to point to the local storage 215 before the time-to-live (TTL) applied to the message data objects lapses.

In operation 350, the object retention system 150 determines the TTL applied to some or all message objects has lapsed. For example, the metadata module 220 can receive an indication from a running TTL mechanism that a subset of message objects in local storage devices 125A-B has a TTL that has expired (e.g., a time of retention in local storage has expired).

In operation 360, the object retention system 150, when the TTL value assigned to the one or more message objects lapses, updates the metadata index at the local storage device with information that indicates the one or more message objects are stored in the cold storage device. For example, the metadata module 220 modifies the metadata index 140 or 225 to point or refer to the message data objects stored at the remote storage device 217 when the TTL lapses.

In some cases, the local storage 120 includes a deleted object store 140, or another storage location that contains message objects and is only accessible by network administrators. In such cases, when the TTL lapses, the system 150 can also store a copy of the one or more message objects to the deleted objects store 140 associated with the local storage 120 (following the data retention standards). The systems and methods, therefore, can continue to utilize a standard-mandated deleted object store 140 while also providing the enhanced object storage architecture described herein, which is optimized for managing, and retaining, billions of message objects.

In some embodiments, the object retention system 150 provides for flexible retention of message objects, such as for message objects actively deleted by subscribers of the network 102 (e.g., owners or creators of the message objects). For example, the system 150 can determine that a subscriber of the telecommunications network 120 has deleted the one or more message objects before the TTL is set to expire, update the metadata index 140 at the local storage device to indicate that the one or more message objects have been deleted by the subscriber of the telecommunications network 102, and set a time-to-live value (e.g., one year) for message objects stored at the cold storage device (e.g., site 170A) that reflects the deletion of the one or more message objects by the subscriber.

As another example, the system 150 can determine that a subscriber of the telecommunications network 102 has deleted the one or more message objects after the TTL expires, update the metadata index 140 at the local storage device to indicate that the one or more message objects have been deleted by the subscriber of the telecommunications network, and removing the one or more message objects from the cold storage device 170A.

Thus, in some embodiments, the systems and methods described herein provide a new and enhanced object storage architecture for message objects. The architecture facilitates the short-term recovery and long-term retention of message objects. Further, the storage architecture includes an object retention system 150, which employs specific data storage operations (e.g., method 300) to store message objects to storage media within the storage architecture, while also following standards for message retention adopted by OSA and GMSA. The systems and methods, therefore, enable a network carrier to maintain, manage, and retain copies of message objects using storage media suitable for retaining the message objects, without adopting processes that fall out of established retention standards and guidelines, among other benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations can perform routines having steps, or employ systems having blocks, in a different order, and some processes or blocks can be deleted, moved, added, subdivided, combined, and/or modified to provide alternative or subcombinations. Each of these processes or blocks can be implemented in a variety of different ways. Also, while processes or blocks are at times shown as being performed in series, these processes or blocks can instead be performed or implemented in parallel, or can be performed at different times. Further any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method for storing message object data for a wireless telecommunications network, wherein the message object data relates to data to be retained regarding communications over the wireless telecommunications network, the method comprising:
receiving, at a local storage device, one or more message objects sent between subscribers of a telecommunications network;
assigning a time-to-live (TTL) value to the one or more message objects at the local storage device;
retaining the one or more message objects by:
storing the one or more message objects to the local storage device,
wherein storing the one or more message objects to the local storage device includes updating a metadata index at the local storage device with information that identifies a location of the one or more message objects as being the local storage device; and
storing the one or more message objects to an archive storage device associated with the local storage device;
when the TTL value assigned to the one or more message objects elapses, updating the metadata index at the local storage device with information that indicates the one or more message objects are stored in the cold storage device.

2. The method of claim 1, wherein, when the TTL value assigned to the one or more message objects elapses storing a copy of the one or more message objects to a deleted objects data store local to the local storage device, wherein the deleted objects folder is accessible only by an administrator of the telecommunications network.

3. The method of claim 1, further comprising:
determining that a subscriber of the telecommunications network has deleted the one or more message objects before the TTL is set to expire;
updating the metadata index at the local storage device to indicate that the one or more message objects have been deleted by the subscriber of the telecommunications network; and
re-setting a time-to-live value for message objects stored at the archive storage device that reflects the deletion of the one or more message objects by the subscriber.

4. The method of claim 1, further comprising:
determining that a subscriber of the telecommunications network has deleted the one or more message objects after the TTL expires;
updating the metadata index at the local storage device to indicate that the one or more message objects have been deleted by the subscriber of the telecommunications network; and
removing the one or more message objects from the archive storage device.

5. The method of claim 1, wherein the one or more message objects include Multimedia Message Service (MMS) messages, Short Message Service (SMS) messages, or Rich Communication Service (RCS) messages.

6. The method of claim 1, wherein the one or more message objects include call logs or message logs associated with messages transmitted between subscribers of the telecommunications network.

7. The method of claim 1, wherein the one or more message objects include voice mail files or video mail files.

8. The method of claim 1, wherein the local storage device is selected from a group of available local storage devices based on a proximity of the local storage device to a mobile device or network component associated with the one or more message objects in the telecommunications network.

9. The method of claim 1, wherein the archive storage device is selected from a group of available cold storage devices assigned to a phone number or username associated with a subscriber of the telecommunications network.

10. The method of claim 1, wherein the archive storage device stores data in an archive format, different from a standard format, and is remotely located from the local storage device.

11. A non-transitory computer-readable medium whose contents, when executed by a computing system associated with a telecommunications network, causes the computing system to perform a method, the method comprising:
receiving, at a local storage device in communication with the local storage device, one or more message objects transmitted over a telecommunications network;
assigning, to the one or more message objects, a time-to-live (TTL) value to the one or more message objects;
retaining the one or more message objects by:
storing the one or more message objects to the local storage device,
wherein storing the one or more message objects to the local storage device includes updating a metadata index at the local storage device with information that identifies a location of the one or more message objects as being the local storage device; and
storing the one or more message objects to an archive storage device associated with the local storage device;
when the TTL value assigned to the one or more message objects lapses, updating the metadata index at the local storage device with information that indicates the one or more message objects are stored in the archive storage device.

12. The non-transitory computer-readable medium of claim 11, wherein, when the TTL value assigned to the one or more message objects lapses, storing a copy of the one or more message objects to a deleted objects data store local to the local storage device, wherein the deleted objects folder is accessible only by an administrator of the telecommunications network.

13. The non-transitory computer-readable medium of claim 11, further comprising:
determining that a subscriber of the telecommunications network has deleted the one or more message objects before the TTL is set to expire;
updating the metadata index at the local storage device to indicate that the one or more message objects have been deleted by the subscriber of the telecommunications network; and
setting a time-to-live value for message objects stored at the archive storage device that reflects the deletion of the one or more message objects by the subscriber.

14. The non-transitory computer-readable medium of claim 11, further comprising:
determining that a subscriber of the telecommunications network has deleted the one or more message objects after the TTL expires;
updating the metadata index at the local storage device to indicate that the one or more message objects have been deleted by the subscriber of the telecommunications network; and
removing the one or more message objects from the archive storage device.

15. The non-transitory computer-readable medium of claim 11, wherein the one or more message objects include RMS messages or RCS messages.

16. The non-transitory computer-readable medium of claim 11, wherein the one or more message objects include call logs or message logs associated with messages transmitted between subscribers of the telecommunications network.

17. The non-transitory computer-readable medium of claim 11, wherein the one or more message objects include voice mail files or video mail files.

18. The non-transitory computer-readable medium of claim 11, wherein the local storage device is selected from a group of available local storage devices based on a proximity of the local storage device to a mobile device or network component associated with the one or more message objects in the telecommunications network.

19. The non-transitory computer-readable medium of claim 11, wherein the archive storage device is selected from a group of available archive storage devices assigned to data for the subscriber or a location within the telecommunications network that includes the subscriber.

20. A system for retaining message object data for a telecommunications network, the system comprising:
a data storage component that simultaneously stores message object data to two separate storage locations, including:
a local storage device that stores message data objects for the telecommunications network; and
a remote storage device that also stores the message data objects for the telecommunications network; and
a metadata component that tracks locations of the message data objects,
wherein the metadata component includes a data structure that points to the message data objects stored at the local storage device before a time-to-live (TTL) applied to the message data objects lapses and then points to the message data objects stored at the remote storage device when the TTL lapses.
